(19) United States
(12) Patent Application Publication
(10) Pub. No.: US 2013/0013443 A1
(43) Pub. Date: Jan. 10, 2013

(54) METHOD AND SYSTEM FOR PROVIDING A REVERSE AUCTIONING RECRUITING EXCHANGE

(76) Inventor: Alayna Jean Christie, Calgary (CA)

(21) Appl. No.: 13/634,855

(22) PCT Filed: Mar. 14, 2011
(86) PCT No.: PCT/CA11/50140

§ 371 Date: Sep. 13, 2012

Related U.S. Application Data
(60) Provisional application No. 61/313,735, filed on Mar. 13, 2010.

(30) Foreign Application Priority Data
Mar. 14, 2011 (CA) PCT/CA2011/050140

(51) Int. Cl. G06Q 30/08

(52) U.S. Cl. 705/26.4

(57) ABSTRACT

An internet-based competitive pricing and bidding transaction system includes one or more transaction processing servers that interface and communicate over the internet with client computer systems of prospective online recruiting organizations, recruiting and staffing professionals and a plurality of related information databases. The transaction processing system handles online communications and procedures for conducting reverse auctions for delivery of staffing services and maintains a registration database of service providers and prospective customers of those services (recruiting organizations). Information relative the performance of the service provider is collected for each transaction and is used to create an automated recommendation that is provided to the requester of a staffing service, which results in the selection of a unique and exclusive service provider. Methods for managing collaboration among service providers are provided, which include notification, sub-provider selection and fee splitting management.

### FIELD OF THE INVENTION

The exemplary non-limiting illustrative embodiments disclosed herein relate to a method and system for implementing a reverse auctioning recruiting exchange via the Internet to serve as a marketplace for recruiting organizations and staffing professionals.

### BACKGROUND OF THE INVENTION

Today's real estate industry evolved from several visionaries establishing a competitive but cooperative marketplace, by developing a comprehensive listing of all available properties through a Multiple Listing Service (MLS). An MLS is a database used by real estate agents representing clients (sellers) under a listing contract, to widely share information about property and assets with other real estate agents representing potential home buyers. The MLS system and database enables an efficient exchange of information between two realtors, through a brokerage who has licensed access to the database, under a standard listing agreement and shared commission model. These services have consistently improved since the mid-1950's; from shared loose-leaf listings to the robust, web accessible databases of today.

On the other hand, the recruitment industry started in the midst of the industrial boom shortly after World War II, when companies were having a hard time finding labor. They enlisted the help of friends to help out with big recruiting drives, until someone demanded to be paid for their services. Hence the first fee for recruitment service and an entire industry was born. Today, the recruitment services industry, like real estate boards, has several trade associations on both a regional and national level, that sets a code of conduct, shares best practices, lobbies the government, and provides a forum for educational and networking events within the industry.

However, in sharp contrast to the real estate industry, the lack of a shared job listings database among the recruiter community keeps them operating much more independently of one another. As a result, recruitment trade associations do not have near the industry clout as real estate boards. Real estate boards by virtue of their ability to control licensing, deny board membership and as act as a gatekeeper to the MLS wield substantive power as a regulatory body and watchdog within their own industry. It is clear that the real estate industry carries much more industry clout by ownership of access to the MLS.

Moreover, most employers use job boards as their first and cheapest source of recruitment advertising, though they often capture active job seekers, who are not always the best candidates available. However, employers will engage a recruiting firm to find talent after they exhaust their own advertising efforts. Unfortunately, studies have shown that the risk to an employer hiring an unemployed candidate increases their risk of turnover two to three times. Another study found a dramatic productivity variance between top performers and other workers. (Hunter, J. E., F. L. Schmidt & M. K. Judiesch, “Individual Differences in Output Variability as a Function of Job Complexity.” Journal of Applied Psychology 75, 1990, 28-42). They found that the top 1% of workers were anywhere from 50% to 127% more productive than the average workers, depending on the complexity of the job—the more complex, the higher the productivity Sales organizations have learned this early on, and are known to skip job advertising and go directly to the source of the hidden talent pool—the recruiters. With such numbers, it hasn't taken long for the recruitment industry to grow in infancy to a mainstream market representing a North American Market of over $80,000,000 and over 60,000 firms nationally.

As Sam Corea of Re/max House of Real Estate in Calgary sums up his industry's value with a catchy tag line, “Marketing your home for all its worth”, so too have recruiters begun to win back mindshare over job boards. “Hiring companies now understand the difference in value between simply listing a job on a board or marketing your company's job opening for all its worth through a recruiter,” says Alayna Christie President of her own Canadian Recruitment firm.

Forward thinking realtors, whether by accident or by design, have been able to capture market share by locking up the supply chain of contracted home listings for sale, by selling their value. As seen in the real estate industry, agents are only compensated if they successfully broker a home purchase between a buyer and a seller. Recruiters, likewise, work to fulfill both ends of a contract by bringing together both the employer and candidate, for a successful hire. In both industries, agents and recruiters are compensated for brokering two parts of a deal on a split commission basis, as a percentage of a deal. In real estate, fees vary slightly across provinces but generally represent about 5% of the closing deal size. However, a recruiter can charge between 20-30% of a deal. For example, a typical real estate transaction on a $500,000 home would net $25,000 in fees between two realtors. By comparison, a recruiter who brokers both ends of a deal through the Recruiter Listing Service would earn $25,000 on a $100,000 salaried position with other recruiters representing the potential candidates to fulfill that job.

The current need for recruiters is increasing daily. Companies will see their intellectual capital leave the industry en masse with the exiting of the baby boomers from the labor market, further increasing the demand for recruitment services. Moreover, the average tenure of an employee is decreasing drastically from the range of 8.9 years for baby boomers at the management level down to a record low of 2.4 years among younger generations. This will increase hiring costs exponentially. Furthermore, the adoption of social media and online corporate networks like LinkedIn and Facebook effectively means that the agency's proprietary database of candidates now becomes open source. The boom of the job boards had given rise in recent years, but is giving way to a bust in 2011 and beyond. The hype of Applicant Tracking Systems and e-recruitment vendors (over 400) has also fallen significantly short of their touted panacea of the hiring and sourcing challenges of companies. Plus, the recent economic downturn has resulted in a bigger pool of candidates, but no means to categorize them and determine the more qualified and productive candidates—the cream of the croup. Recruitment agency revenues are down significantly in the recession creating turmoil, turnover and reduced recruiter revenue.

On the whole, the market is ready for change whenever market forces come together to create the stage for disruption. And, these market forces exist right now. A need exists for a system and method for implementing a reverse auctioning recruiting exchange via the Internet to serve as a marketplace for recruiting organizations and staffing professionals. A further need exists for such a system and method that reduces transactional costs associated with providing staffing services and increases the quality of those services. A need exists for a central listing system so that employers and hiring personnel have access to a set pool of employment candidates. A further need exists for a candidate to be able to submit a resume to one central listing system rather than multiple recruitment agencies and recruiters. A further need exists for recruiters to be able to easily access candidates and job openings and to facilitate employment of the candidates and fulfilling employer's open job listings. A further need exists for a central database of job openings or listings. A further need exists for a central database of candidate resumes.

A further need exists for employers/hiring managers to be able to designate one Exclusive Listing Recruiter (ELR) to screen, interview and recommend and manage interaction with employer. A further need exists to designate all other recruiters as “Referring Recruiters” to source, recommend and refer qualified candidates to one ELR to streamline recruiter engagement practice. A further need exists for one entity (the exchange) to act as the financial clearing gateway, provide service level fulfillment and guarantee refund commitment on behalf of multiple small service providers.

These needs and many others are met by a process for implementing a reverse auctioning recruiting exchange using the inventive method which uses the Internet to serve as a marketplace for recruiting organizations and staffing professionals. Other advantages of the present invention will become apparent from the following description and appended claims.

### DRAWINGS

FIG. 1 is a diagram of one embodiment of the present invention for a reverse auctioning recruiting exchange system and process.

FIG. 2 is a block diagram of an embodiment of a system for a reverse auctioning recruiting exchange of the present invention.

FIG. 3 is a flow diagram of an embodiment of the process for a reverse auctioning recruiting exchange of the present invention.

### SUMMARY OF THE INVENTION

A method and system for implementing a reverse auctioning recruiting exchange via the Internet to serve as a marketplace for recruiting organizations and staffing professionals is disclosed. More particularly, the exemplary non-limiting illustrative embodiments disclosed herein relate to a method and system for implementing and online transaction system that reduces transactional costs associated with providing staffing services and increase the quality of those services by providing a software service and a web site that provides recruiting organizations recommendations on service providers and allows the recruiting organization to select a particular service provider as the exclusive service provider and allows the exclusive service provider to cooperate with other service providers to deliver the service and manages the entire transaction on behalf of the recruiting organization, the exclusive service provider and all other service providers involved.

### DETAILED DESCRIPTION OF THE INVENTION

The invention is a method and system for a reverse auctioning recruiting exchange (RARE), which may include for instance software services and a website for submitting recruiting needs, selecting an exclusive recruiting provider and managing staffing transactions that is accessible via the Internet using a conventional computer with a browser or a standard Internet server and which enables an online visitor/user to the website or of the service to submit staffing needs, participate in online auctions for recruiting services, review and select exclusive service provider, manage collaboration through service providers, manage entire staffing transactions with all relevant parties, arrange financing and manage payments for services provided, review transaction information and manage feedback on service providers.

A non-limiting description of an exemplary on-line reverse auctioning recruiting exchange (RARE) service method and system is provided herein. The disclosed exemplary RARE service method and system, in addition to hosting an on-line recruiting auctioning system, includes interactive tools for arranging financing of successful bids, performing on-line research of proffered services and providers, as well as participating on-line in other recruiting related negotiations and transactions.

The inventive on-line RARE system provides an Internet accessible web-site that acts as a “one stop” full service on-line marketplace for use by staffing service providers and prospective consumers for negotiating and consummating transactions for proffered staffing services and products. The on-line RARE service provides Internet access to customized proprietary databases and interactive tools for obtaining credentials information and for conducting on-line research concerning prospective staffing service providers/facilities, and for making on-line payments/arrangements for staffing service financing.

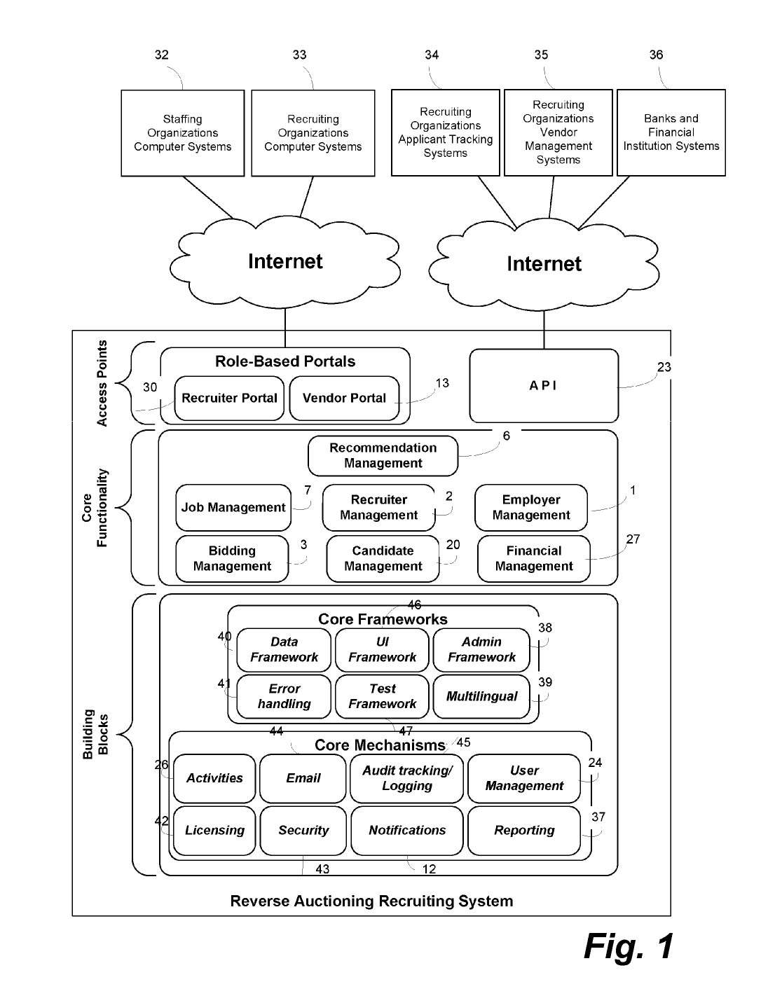

FIG. 1 is a diagram of an embodiment of the present invention including a computer system such as user computers, cloud computers and server computers connected or connectable to the Internet (50). Although the Internet (50) is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers may include various hardware, software, applications, programs and tools. Such computers may also include a hard drive, or other type of data storage devices, monitor, keyboard, pointing or selecting device, etc. The computers may operate using an operating system such as Unix/Linux or Windows by Microsoft, etc. Each computer may include a central processing unit (CPU), data storage device, and various amounts of memory including RAM and ROM. Such computers may also include various programming, applications, and software to enable searching, search results, and advertising, such as keyword searching and advertising in a sponsored search context. A data storage device to house and store certain database such as the recruiter database (1), staffing vendor database (2), job database (7), bidding database (8), candidate database (20) and others, includes one or more databases, as well various engines such as, but not limited to, a bidding engine (3) and a recommendation engine (6), along with various other programs, such as but not limited to a ranking program.

The engineers and programs in the present invention are intended to broadly include programming, algorithms, applications, software, graphical user interfaces, models, and other tools or procedures necessary to implement or facilitate methods and systems according to embodiments of the invention, or computerized aspects thereof, whether on one computer or distributed among multiple computers or devices. These include local and global adjustment, decision making, or optimizations, ranking, pricing, allocation, scheduling, serving, and other techniques. In various embodiments, the elements of the RARE may exist on one computer, or may exist on multiple computers, devices, or locations.

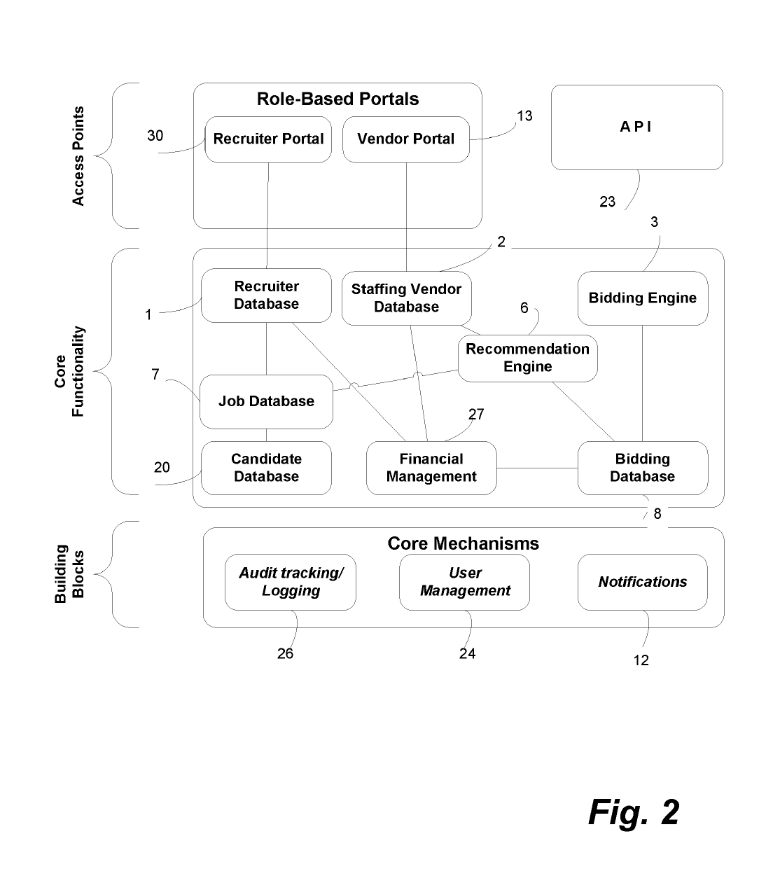

FIG. 1 describes the overall system and method of the present invention and FIG. 2 describes the system of the invention. The exemplary inventive RARE system provides the ability for first-time users/visitors, through the user management sub-system (24), from a recruiting organization to register into the system by filling out specific information including but not limited to personal profile, business profile, organization name and contact information. Each user may be required to have specific access via, for example, a user identification and password, or access through a specific internet protocol address, and belong to an existing organization. The information is stored in the recruiter database (1).

The RARE system may receive information from any number of other systems or programs, such as, but not limited to staffing organization computer systems (32), recruiting organizations computer systems (33), recruiting organizations applicant tracking systems (34), recruiting organizations vendor management systems (35), banks and financial institution systems (36) and the like.

The inventive exemplary RARE system provides the ability, through the user management sub-system (24), for first-time users/visitors from a staffing vendor organization to register into the system by filling out specific information including but not limited to personal profile, business profile, organization name and contact information. Each user is required to have specific access via, for example, a user identification and password, or access through a specific internet protocol address, and belong to an existing organization. The information is stored in the Staffing Vendor database (2).

New job vacancies can be added (5) within the exemplary RARE system by a registered user belonging to the recruiter database (1) through the recruiter portal (30). The user needs to provide information describing the vacancy. The information includes, but is not limited to, a job title, a job description, and qualifications required for the job. The user is also able to provide an opening bid amount that will serve as a starting point for the reverse bidding engine (3) later on during the bidding process (4). The user is also able to provide a time frame for accepting the bids from the staffing service providers. This time frame will be used later in the bidding process (4) for determining the end of that process. The user is also able to create a questionnaire for the staffing providers to fill that will later be used to determine the exclusive staffing provider. The information relating to the job vacancy is stored in the job database (7).

The inventive exemplary RARE system also provides the ability to recommend a service provider (9) for a particular job vacancy through the recommendation engine (6).

The recommendation engine (6) uses information from the staffing vendor database (2), compares each staffing vendor with the characteristics of the job vacancy, compares each staffing vendor with other similar staffing vendors, and provides a score for each staffing vendor.

The recommendation engine (6) also uses information from the bidding database (8), compares results and feedback from past biddings with the characteristics of the job vacancy, and provides a score for each staffing vendor. Both calculated scores are then used to determine a list of recommended staffing providers to the recruiter user.

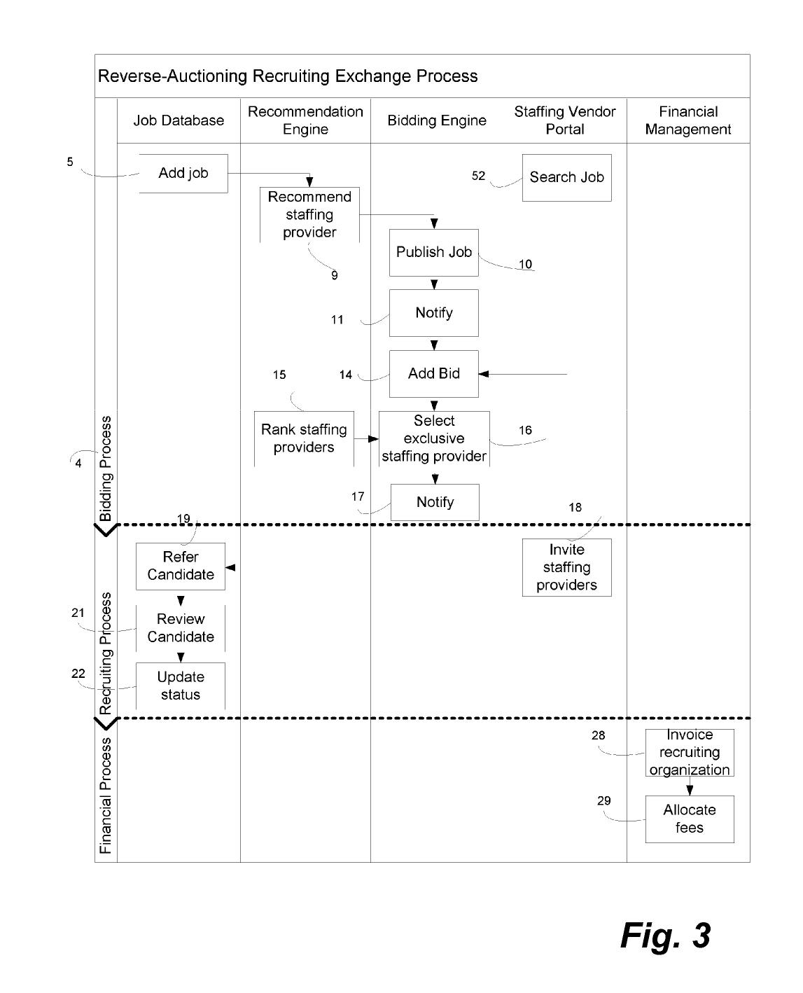

FIG. 3 is a flow diagram of an embodiment of the [present invention for the process. The inventive exemplary RARE system also provides the ability for the recruiter user to publish the job vacancy (10), i.e. make a job vacancy in the job database (7) available to staffing providers through the bidding engine (3). The recruiter user can make the job vacancy open to all staffing providers or only to a smaller subset of all staffing providers based on the recommendations of the recommendation engine or on any other rationale.

The inventive exemplary RARE system also provides the ability for staffing providers to be notified (11) of new job vacancies being available to them, The notification sub-system (12) determines the staffing vendor users whom the job vacancy is available to and communicates with them to make that information available through a variety of communication mechanism including but not limited to emails, text messages (SMS), and staffing vendor portal (13).

The inventive exemplary RARE system also provides the ability for all staffing providers to search (52) for job vacancies that are available to them through the staffing vendor portal (13).

The inventive exemplary RARE system and process also provides the ability for staffing vendor users for whom the job vacancy is available to express their interest in the job vacancy and submit a bid (14). The bid information is stored in the bidding database (8) and includes but is not limited to the amount for the service fee, a timeline for providing candidates, a description of the recruiting process the staffing provider intends to follow, responses to the questionnaire provided by the recruiting organization, and any other additional information that is deemed relevant to the bidding process by the staffing provider user.

At any moment in time, and more especially at the end of the bidding period of a job vacancy, the exemplary RARE system and process, through its recommendation engine (6) also provides the recruiter user with a ranked list of staffing providers (15) who have created a bid in the bidding database (8) for a particular job vacancy. The recommendation engine (6) provides its recommendations based on various criteria including but not limited to bidding amount, staffing provider specialty and how it relates to the type of job vacancy the bid is for, staffing provider performance for past services, and staffing provider performance for past services with characteristics similar to the job vacancy.

At any moment in time, and more especially at the end of the bidding period of a job vacancy, the exemplary RARE system and process, through its bidding engine (3), provides the ability to the recruiter user to review all bids from all staffing providers. The exemplary RARE system provides the ability to the recruiter user to, for example, including but not limited to have the ability to sort or slice and dice the information based on various criteria including but not limited to bidding amount, staffing provider specialty and how it relates to the type of job vacancy the bid is for, staffing provider performance for past services, and staffing provider performance for past services with characteristics similar to the job vacancy.

The inventive exemplary RARE system and process also provide the ability to select an exclusive staffing provider for the vacancy (16) for a set period of time. At the moment the selection is done, the bidding engine (3) notifies (17) through the notification engine (12) of the decision of the recruiter user the selected staffing provider and all rejected staffing providers, updates the bidding database (8) to mark the selected bid, and updates the bidding database (8) to close all other bids for this particular job vacancy.

The inventive exemplary RARE system and process also provides the ability for a staffing service provider user to contact other staffing providers and to invite them to participate in referring candidates to fill the job vacancy (18). The staffing service provider user can select specific staffing service provider users or simply make the job vacancy open, meaning that any staffing service provider is able to submit candidate referrals.

The inventive exemplary RARE system and process also provides the ability for the exclusive staffing provider to refer candidates on the job vacancy (19). The candidate information is added to the candidate database (20) and includes but is not limited to candidate first and last name, contact information, and a resume. Whenever the exclusive staffing provider refers a candidate it is immediately added to the job vacancy.

Further, the exemplary RARE system and process also provides the ability for non-exclusive staffing provider to refer candidates on the job vacancy (19). The candidate information is added to the candidate database (20) and includes but is not limited to candidate first and last name, contact information, and a resume. Whenever the non-exclusive staffing provider refers a candidate, the exclusive staffing provider is notified through the notification sub-system (12). In this context, the candidate record is not yet attached to the job vacancy record in the job database (7).

The inventive exemplary RARE system and process also provides the ability for both exclusive and non-exclusive staffing providers to refer candidates who already exist in the candidate database (20). In this context, candidate information is added to the existing record in the candidate database (20).

The inventive exemplary RARE system and process also provides the ability for the exclusive staffing provider to review candidate records in the candidate database (20) that have been submitted by non-exclusive staffing providers.

The inventive exemplary RARE system and process also provides the ability for the exclusive staffing provider to review (21) the candidate submitted by the non-exclusive candidate by accessing the candidate record in the candidate database (20).

The inventive exemplary RARE system and process also provides the ability for the exclusive staffing provider, after reviewing the candidate record (21), to approve the candidate for further consideration. The candidate record is attached to the job vacancy record in the job database (7) and the non-exclusive staffing provider is notified through the notification sub-system (12).

The inventive exemplary RARE system and process also provides the ability for the exclusive staffing provider, after reviewing the candidate record (21), to decline the candidate for further consideration. The non-exclusive staffing provider is notified through the notification sub-system (12).

The inventive exemplary RARE system and process also provides the ability for the exclusive staffing provider to modify the status (22) of the candidate within the recruiting process. The list of available status is different for each recruiter. The list of available status is also different depending on the current status of the candidate for a given job vacancy.

A subset of the list of available status is available for the non exclusive staffing provider to change.

Whenever the status is changed in the candidate database (20), the exclusive staffing provider and the non-exclusive staffing provider who referred the candidate are notified of the changes through the notification sub-system.

The inventive exemplary RARE system and process also provides the ability to update the job vacancy record in the job database (7) with a start date for the candidate who has been selected to fill the vacancy.

Moreover, the exemplary RARE system and process also provides the ability, through the financial management (27) sub-system, to invoice the recruiting organization (28) for the fee defined in the bidding database (8) at the end of the bidding process (4) at a predefined date that is the start date of the candidate as entered in the job database (7).

The inventive exemplary RARE system and process also provides the ability, through the financial management (27) sub-system, to allocate the fee (29) collected during the invoicing phase (28) to all the parties involved during the transaction. Those parties include but are not limited to the organization that operates the RARE system, the exclusive staffing provider, and the non-exclusive staffing provider that submitted the candidate who has been selected to fill the vacancy.

Further, a user management (24) system may be employed with an embodiment of the RARE exchange. Many other systems and functionality are possible such as including, but not limited to a reporting mechanism or system (37), administrator framework (38), multilingual systems (39), data framework (40), an error handling system or program (41), a licensing program or system (42), a security system or program (43), an email system or program (44), core mechanism system or program (45), an UI framework (46), test framework (47), among other known or unknown systems, programs and general functionality.

The inventive exemplary RARE system also provides the ability to record all the activities occurring within the system through the Audit Tracking and Logging sub-system (ATL) (26). The ATL allows to track all activities related to a transaction and is a key ingredient for the recommendation engine (6) to categorize and quantify each staffing service provider and recruiting organization.

The inventive exemplary RARE system also provides the ability to interact with external software systems including but not limited to Applicant Tracking Systems, Vendor Management Systems, Human Resource Management Systems, and Staffing Front- and Back-Office Systems through an Application Programming Interface (31).

The present invention is even further directed to computing systems comprising at least one device operatively adapted to access a secure web-based system and utilize one or more of the disclosed methods for providing a reverse auctioning recruiting exchange between various organizations and vendors for the purpose of matching a candidate with an open job position. Such a computing system may comprise at least one device operatively adapted to access the secure web-based system and utilize one or more of the disclosed methods for the inventive RARE. A variety of devices may be used to access a secure web-based system and utilize one or more of the disclosed methods for RARE such as, but not limited to, personal computers, server computers, hand-held or laptop devices (e.g., computers, smart phones, notepads, or any other device with Internet access), multiprocessor systems, microprocessor-based systems, set top boxes, programmable consumer electronics, network PCs, minicomputers, mainframe computers, distributed computing environments that include any of the above systems or devices, and the like,

The inventive system and method for implementing a reverse auctioning recruiting exchange via the Internet serves as a marketplace for recruiting organizations and staffing professionals. Several needs may be fulfilled by the invention. The inventive system and process also reduces transactional costs associated with providing staffing services and increases the quality of those services. The inventive system also reduces ‘time to fill’ open orders on behalf of the employment company by engaging multiple recruiters through one ELR to simultaneously work on one open order in a coordinated, efficient fashion. The Inventive system also reduces contract risk and potential for duplicity of candidate referrals by referring agencies often leading to double billing. The inventive system also eliminates the employment company from having to accept a credit in the event of a service guarantee fulfillment breach (the agency referred candidate leaves for any reason whatsoever within the first 90 days).

Further the inventive system and process allows employers/hiring managers to be able to designate one ELR to screen, interview and recommend and manage interaction with employer. Moreover, the inventive system and process designates all other recruiters, besides the ELR, as Referring Recruiters to source, recommend and refer qualified candidates to one ELR to streamline Recruiter engagement practice. In addition, the inventive system and process allows one entity (the exchange) to act as the financial clearing gateway, provide service level fulfillment and guarantee refund commitment on behalf of multiple small service providers,

Further, users of the inventive system and process should be able to fill open employment positions more quickly with better quality candidates. Moreover end uses of the of the inventive system and process will save money by leveraging the power of the global recruiting marketplace in a reverse auction platform and efficiently manage their activities with a simple and easy to use interface.

In addition, end users of the of the inventive system and process will be able to access an online forum allowing end users/employers to leverage an independent recruiting consortium in the global marketplace, while at the same time streamlining their process and decreasing administrative demands. The inventive system creates a network where end users/employers are able to exponentially reach the best recruiters and candidates from all over the world.

The systems and methods of the present invention provide many benefits over prior methods of matching employers with open job positions with eligible candidates.

The invention has been described in terms of embodiments thereof, but is more broadly applicable as will be understood by those skilled in the art. The scope of the invention is only limited by the following claims.

I claim:

1. A computer implemented method for conducting negotiations and/or transactions for services between consumers and professional service providers of staffing services via the Internet, comprising:
providing a computerized transaction system having one or more web-site servers in communication with the Internet, the servers including a fee negotiations arbitration engine for managing on-line posting and auctioning of staffing services by one or more professional service providers, the transaction system further including one or more databases for storing categorization and quantification information of each professional service provider and a recruiting organization registered to use the transaction system; and
using the transaction system to provide an Internet accessible web-site that functions as a staffing services market exchange for conducting on-line negotiations and/or transactions between one or more prospective recruiting organizations and one or more staffing service providers over the Internet, wherein the Internet accessible web-site presents on-line offerings and bids for staffing via said website, and wherein the server automatically researches, verifies and updates the categorized and quantified information, of each professional service provider transparently to on-line users and makes that information available to prospective registered bidders online.

2. The method of claim 1 further comprising a data repository containing listing information from a plurality of databases comprising at least the information related to each transaction.

3. The method of claim 2 wherein the information within the plurality of databases includes information for a staffing position and information for a plurality of candidates.

4. The method of claim 3 wherein the staffing position information includes one or more of a job title, job duties, educational requirements, professional requirements, certification listing, reference listing, or a combination thereof.

5. The method of claim 3 wherein the candidate information includes one of more of current job title, past job titles, professional history, salary history, educational history, reference listing, certification listing, or a combination thereof.

6. The method of claim 1 further comprising the step of ranking one or more candidates relative to a staffing position.

7. The method of claim 6 further comprising distributing the ranking information and the listing information for such ranked candidates from the data repository to an end user.

8. The method of claim 1 wherein at least some negotiations between one or more on-line prospective recruiting organizations and one or more staffing service providers are conducted as a conventional on-line auction process.

9. The method of claim 1 wherein at least some negotiations between one or more on-line users and one or more staffing service providers are conducted as an on-line reverse auction process.

10. The method of claim 1 wherein said databases include information relating to past performance and behavior of one or more of said recruiting organizations and/or one or more of said staffing service providers.

11. The method of claim 1 wherein a particular staffing service provider acts as the exclusive provider for a given transaction.

12. The method of claim 1 wherein the exclusive staffing provider of a transaction collaborates with other staffing providers for the purpose of fulfilling the said transaction.

13. The method of claim 1 wherein the fees associated to a transaction are automatically split between all providers involved in the said transaction.

14. An apparatus for implementing an Internet accessible reverse auction recruiting exchange for staffing service providers and recruiting organizations, comprising:
at least one server computer system having an interface for communicating over the Internet;
at least one bidding arbitration engine; and
at least one database search engine,
wherein an interactive on-line staffing services negotiation processing web-site is implemented by said server computer system, the web-site serving as an on-line reverse auction recruiting exchange for enabling one or more entities to participate in business transactions related to the receiving of staffing services from staffing service providers via the Internet.

15. An on-line reverse auction recruiting exchange system implemented over the Internet, said system enabling one or more staffing providers to proffer staffing services via a network, said system comprising:
a computer system connected to the Internet;
a computer-readable storage device connected to said computer system for storing one or more information databases, including at least one database containing information concerning registered service consumers, at least one database containing information concerning registered service providers, and at least one database containing information concerning categorization and quantification information for each registered service provider; and
a mechanism for controlling said computer system for maintaining said information databases and for causing the computer system to provide an interactive on-line Internet-accessible staffing services advertising and negotiations processing web-site for posting and managing on-line service fee negotiations between on-line consumers and service providers of staffing services, wherein an on-line recruiting organization user who accesses the web-site is enabled to participate in on-line auctions for proffered staffing services.

16. The system of claim 15 wherein said computer system further provides a user of said network with on-line access to information databases and services which interactively assist said user in conducting on-line research for determining an appropriate staffing service provider.

17. A method for providing an Internet accessible reverse auction recruiting exchange service for conducting negotiations and/or transactions for services between consumers and service providers of staffing services, comprising:
providing at least one server computer system in communication with the Internet, said computer system comprising one or more servers and a plurality of databases for maintaining identification information and other data relating to on-line users and staffing service providers, said one or more servers hosting an interactive on-line staffing services negotiations processing web-site wherein a user is enabled to conduct one or more transactions on-line via said web-site to obtain proffered staffing services; and
using said server computer system to provide an Internet accessible web-site, said web-site functioning as an on-line reverse auction recruiting exchange for processing negotiations between one or more on-line consumers and one or more service providers of staffing services.

18. The method of claim 17 further comprising communicating with one or more servers based on a link or command defined by said website to validate a service provider's credentials.

19. The method of claim 17 wherein said databases include information relating to past performance and behavior of one or more of said recruiting organizations and/or one or more of said staffing service providers.

20. The method of claim 17 wherein a particular staffing service provider acts as the exclusive provider for a given transaction.
